(19) United States
(12) Patent Application Publication
(10) Pub. No.: US 2006/0028547 A1
(43) Pub. Date: Feb. 9, 2006

(54) Integrated active surveillance system

(76) Inventor: Chao-Hung Chang, Taichung (TW)

Correspondence Address: Chao-Hung Chang, 7F., No. 213 Civic Boulevard, Sec. 4, Taipei, 105, TW

(21) Appl. No.: 10/910,753

(22) Filed: Aug. 4, 2004

(51) Int. Cl. H04N 7/18; H04N 9/47

(52) U.S. Cl. 348/143

(57) ABSTRACT

The present invention relates to an integrated active surveillance system, which can automatically identify targets of interest, take the magnified images of such targets, and store and transmit the images to remote monitors. The system contains: one image-taking device, which includes one camera module to take the wide-angle image of the surveillance area and magnified narrow-angle images of targets of interest; one image process device, which is connected to the image-taking device, screening wide-angle images to search for the targets of interest, and the magnified images of the targets are taken; one memory device, which is connected to the image process device, saving both the wide-angle images and magnified images; one transmitting device, which is connected to the memory device, transmitting image data to at least one remote monitor; and one control device, which is connected to all devices mentioned above, to coordinate the image-taking directions, image data processing, storing, and transmitting.

### FIELD OF THE INVENTION

The present invention relates to a video surveillance system, particularly to an integrated active surveillance system.

### BACKGROUND OF THE INVENTION

While the modern society changes quickly and the urban population increases constantly, the crime rate also increases. Surveillance cameras are now very commonly installed at main and back streets, stores, banks, and public buildings to protect the general public and deter criminal acts. These surveillance cameras record images of criminals and provide the police with clues for cracking criminal cases.

A typical surveillance system includes cameras installed at open, public places, such as street intersections, outside of stores, etc., and a control system and monitors mounted in a security guard office or a police station. When a guard finds any abnormal condition over a monitor screen, he could actuate the alarm system to inform other security guards to check out, and simultaneously control, remotely, the camera to lock in and zoom in the suspect's magnified images, so as to assist the police to identify the individual. In a conventional surveillance system, a control signal line and a video transmission line are extended from the camera mounted outside to the control system and monitors installed in the security guard office or the police station. The transmission lines between the camera and the monitoring end, including the control system and the monitors, not only transmit control signals but also image data lead to many problems, such as signal degrading, high wiring cost, and easy failure of the lines.

Moreover, the control system at the monitoring end requires computers, control software, image processing hardware, memory units, and other hardware that are expensive. The conventional surveillance system is also complicated to install and operate.

It is therefore important to develop an economical and reliable surveillance system that reduce the loads of the transmission line between the surveillance camera and the monitoring end, lower the cost for the hardware of the control system, and relieve the security guards from heavy burden in work.

### SUMMARY OF THE INVENTION

A primary objective of the present invention is to provide an integrated active surveillance system that integrates a control device and an image-taking device, in which the control device can actively identify and drive the image-taking device to take the images of specific targets, record the images, and transmit the images to a monitor, so as to eliminate manual surveillance operation, reduce the load of the transmission lines between the image-taking device and the monitoring end, and reduce the overall costs for hardware and installation of a surveillance system.

To achieve the above objectives, this invention discloses an integrated active surveillance system capable of automatically identifying targets of interest and transmitting magnified images of the targets to remote monitors. The system contains: one image-taking device, which includes one camera module to take the wide-angle image of the surveillance area and magnified images of targets of interest; one image process device, which is connected to the image-taking device, screening wide-angle images to search for the targets of interest, and the magnified images of the targets are taken; one memory device, which is connected to the image process device, saving both the wide-angle images and magnified images; one transmitting device, which is connected to the memory device, transmitting image data to at least one remote monitor; and one control device, which is connected to all devices mentioned above, to coordinate the image-taking directions, image data processing, storing, and transmitting.

### BRIEF DESCRIPTION OF THE DRAWINGS

This invention can be best understood by referring to the following detailed description of the preferred embodiments and the accompanying drawings, wherein

FIG. 1 is a block diagram of an integrated active surveillance system according to the present invention;

FIG. 2 is a block diagram of a first embodiment of the present invention;

FIG. 3 is a block diagram of a second embodiment of the present invention; and

FIG. 4 is a schematic perspective view of a movable reflection unit employed in the present invention.

### DETAILED DESCRIPTION OF THE PREFERRED EMBODIMENTS

Please refer to FIG. 1 that is a block diagram of an integrated active surveillance system 1 according to the present invention. As shown, the integrated active surveillance system 1 of the present invention includes an image-taking device 11, an image process device 12, a memory device 13, a control device 14, and a transmitting device 15. A display device 16 is located at a remote location.

The image-taking device 11 is adapted to take full-view, wide-angle images within a surveillance area, and to take locally magnified, narrow-angle images of targets of interest.

The image process device 12 is adapted to process wide-angle images to search for targets of interest. The targets are selected in one or combination of many different manners, including displacement detection, appearance matching, color matching, size matching, infrared temperature matching, and speed matching, depending on the installation site and the nature of targets. When a target of interest is found, the control device 14 is notified to drive the image-taking device 11 to take closed-up images of the target of interest.

The memory device 13 includes a hard disk drive or other digital memory unit, and is adapted to store the images taken by the image-taking device 11.

The control device 14 may be, for example, a microprocessor for coordinating the image-taking direction of the image-taking device 11, the image processing of the image-process device 12, and the image storing and transmitting of the memory device 13.

The transmitting device 15 is adapted for wired and/or wireless transmission of images stored in the memory device 13 to the display device 16, which may be a monitor and/or a video recorder.

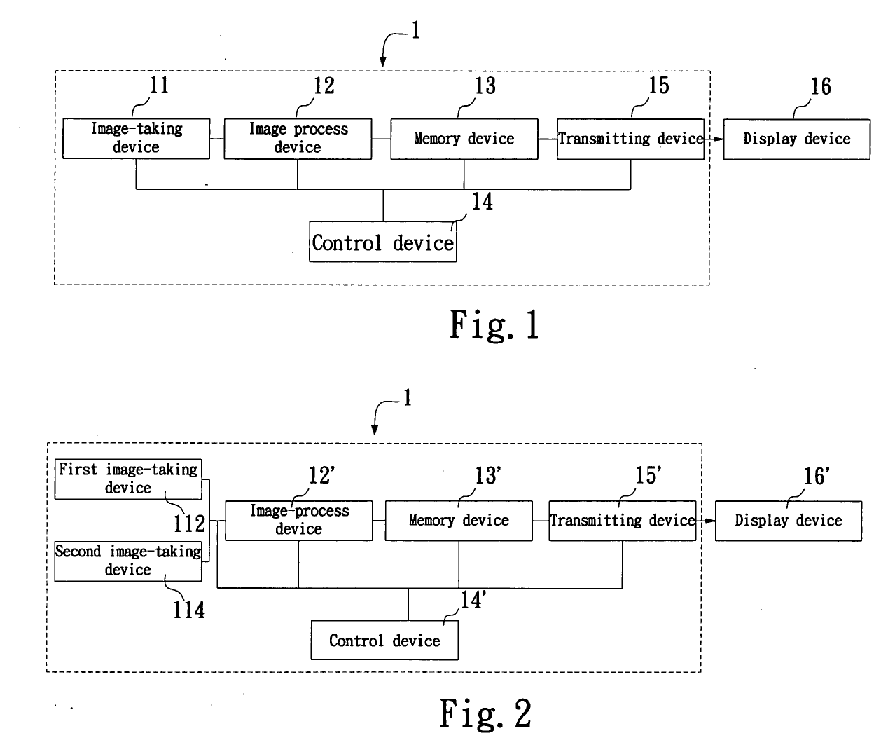

Please refer to FIG. 2 that is a block diagram of a first embodiment of the present invention. As shown, the first embodiment of the present invention includes a first image-taking device 112, a second image-taking device 114, an image-process device 12′, a memory device 13′, a control device 14′, and a transmitting device 15′. A display device 16′ is located at remote site.

The first image-taking device 112 may be, for example, a fixed wide-angle camera for continuously taking wide-angle image signals within a surveillance area in a fixed direction.

The image-process device 12′ may be, for example, a computer or an image-process chip with a built-in image processing program for continuously screening the wide-angle image images taken by the first image-taking device 112 for targets of interest. When any target of interest is found the second image-taking device 114 is driven to take locally magnified images of the target. The targets are selected in one or combination of many different manners mentioned above.

The second image-taking device 114 may be, for example, a movable narrow-angle camera controlled by the control device 14′ to take magnified image of the latest target of interest being designated.

The memory device 13′ may be, for example, a hard disk, a memory, or other digital recording medium, and is connected to all the above-mentioned devices to continuously recording the wide-angle image signals of the surveillance area and the magnified image signals of targets of interest.

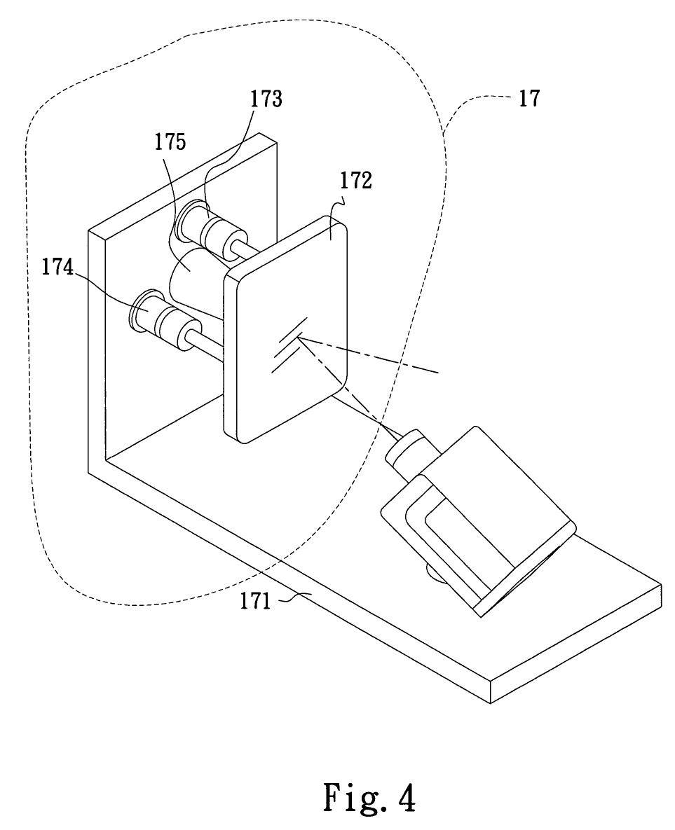

The above-mentioned second image-taking device 114 includes a fixed narrow-angle camera and a movable reflection unit 17 (see FIG. 4) located in front of the narrow-angle camera. The movable reflection unit 17 includes a base 171, a reflection mirror 172, a vertical driving gear 173, and a horizontal driving gear 174. The reflection mirror 172 is connected to the base 171 via a turnable supporting point 175 provided at a rear side of the reflection mirror 172. The vertical driving gear 173 and the horizontal driving gear 174 are fixed on the base 171 and locate at outer periphery of the supporting point 175 with an angle of 90 degrees between them, with front ends thereof separately connected to corresponding points on the rear side of the reflection mirror 172. With these arrangements, the reflection mirror 172 may be driven to different reflecting angles via control of the vertical and the horizontal driving gear 173, 174, so as to change angles for the fixed narrow-angle camera 114 to take images.

The integrated active surveillance system according to the first embodiment of the present invention performs the surveillance basically in the following steps:
1. Using the first image-taking device 112, which is, for example, a fixed wide-angle camera, to continuously taking wide-angle image signals in a fixed direction;
2. Continuously recording the taken wide-angle image signals in the memory device 13′, which is, for example, a hard disk;
3. Using the image-process device 12′ to process wide-angle images searching for targets of interest. The targets are selected in one or combination of many manners, including displacement detection, appearance matching, color matching, size matching, infrared temperature matching, and speed matching, depending on the installation site and the nature of targets.
4. Controlling the second image-taking device 114, which is, for example, a movable narrow-angle camera, or a fixed camera with a movable reflecting device, to take magnified image of the target of interest;
5. Recording the magnified image signals of the target of interest in the memory device 13′; and
6. Using the transmitting device 15′ to transmit the image signals in the memory device 13′ to the display device 16′.

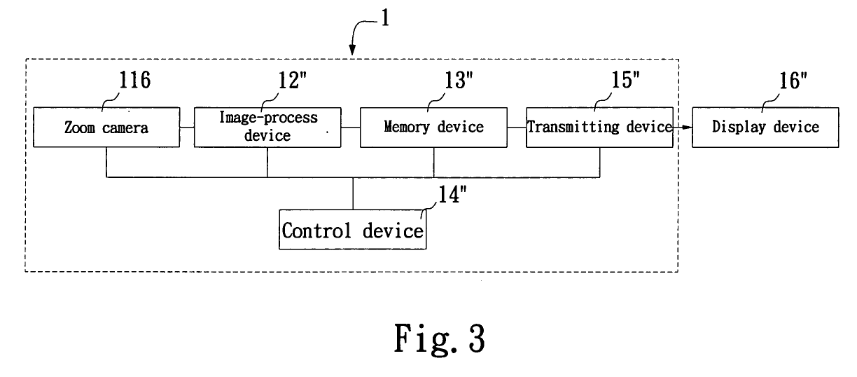

Please refer to FIG. 3 that is a block diagram of a second embodiment of the present invention. The second embodiment performs the surveillance in a manner similar to the first embodiment, except that the second embodiment includes only one image-taking device that is a movable zoom camera 116, in which the zoom lens can be changed from wide-angle to narrow-angle.

The integrated active surveillance system according to the second embodiment of the present invention performs the surveillance basically in the following steps:
a. Using the image-taking device 116, which is a movable zoom camera, to continuously taking wide-angle image signals in a fixed image-taking direction;
b. Continuously recording the taken wide-angle image signals in a memory device 13″, which is, for example, a hard disk;
c. Using the image-process device 12′ to process wide-angle images searching for targets of interest.
d. Convert the movable zoom camera 116 to narrow-angle, move to the direction of the target, and take magnified image of the target of interest;
e. Recording the magnified image signals of the target of interest in the memory device 13″; and
f. Using a transmitting device 15″ to transmit the image signals in the memory device 13″ to a display device 16″.

In short, the present invention provides an integrated active surveillance system that integrates the control device and the image-taking device in one package. The control device can actively identify targets of interest and drive the image-taking device to take magnified images of the targets, record the images in the memory device, and transmit the images to the display device, so as to relieve the security guard from burden in work, reduce the load of the transmission line between the image-taking device and the monitoring end, and reduce the hardware cost of the surveillance system.

The surveillance system of the present invention could therefore satisfy two basic requirements of easy to install and convenient for use.

What is claimed is:

1. An integrated active surveillance system capable of automatically identifying targets of interest, taking and transmitting magnified images of said targets to remote monitors, comprising an image-taking device, an image process device, a memory device, a control device, a transmitting device, and at least one display device;
said image-taking device including at least one set of cameras for taking wide-angle images of full-view and narrow-angle images of said targets of interest within a surveillance area depending on actual need;
said image process device being connected to said image-taking device and adapted to continuously processing said wide-angle images taken by said image-taking device to search for targets of interest and to inform said control device about the directions of the targets so that the magnified images of said targets can be taken;
said memory device being connected to said image-process device for recording said magnified images of said targets of interest and said wide-angle images;
said transmitting device being connected to said memory device for transmitting images stored in said memory device to said at least one display device; and
said control device being connected to said image-taking device, said image-process device, said memory device, and said transmitting device for coordinating directions in which said wide-angle and narrow-angles images are taken, and processing, storing, and transmitting said images in the system.

2. Said integrated active surveillance system of claim 1, wherein said at least one display device is a video monitors or a video recorder.

3. Said integrated active surveillance system of claim 1, wherein said at least one set of cameras includes a fixed wide-angle camera and a movable narrow-angle camera.

4. Said integrated active surveillance system of claim 1, wherein said at least one set of cameras includes a movable zoom camera.

5. Said integrated active surveillance system of claim 1, wherein said image process device is an image-processing chip.

6. Said integrated active surveillance system of claim 1, wherein said image-process device select said targets of interest from said wide-angle images in one or combination of following manners: displacement detection, appearance matching, color matching, size matching, infrared temperature matching, and speed matching.

7. Said integrated active surveillance system of claim 1, wherein said memory device is hard disk drives or digital memory units.

8. Said integrated active surveillance system of claim 1, wherein said control device is a microprocessor.

9. Said integrated active surveillance system of claim 1, wherein said transmitting device is wired and/or wireless transmitting devices.

10. Said integrated active surveillance system of claim 3, said movable narrow-angle camera comprising a movable reflecting unit located in front of a fixed narrow-angle camera.

11. Said integrated active surveillance system of claim 4, said movable zoom camera comprising a movable reflecting unit located in front of a fixed zoom camera.
